(19) United States
(12) Patent Application Publication
(10) Pub. No.: US 2007/0251232 A1
(43) Pub. Date: Nov. 1, 2007

(54) DUCT FOR INTERCONNECTING A COMPRESSOR AND AN INTERCOOLER

(75) Inventors: Petrus Cornelis Gerardus de Kok, Heeze (NL); Christiaan Gerardus Knubben, Eindhoven (NL)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: DAF Trucks N.V., TW Eindhoven (NL)

(21) Appl. No.: 11/739,902

(22) Filed: Apr. 25, 2007

(30) Foreign Application Priority Data
Apr. 26, 2006 (EP) 06113112.4

(51) Int. Cl. F02B 29/04

(52) U.S. Cl. 60/599

(57) ABSTRACT

A duct is provided for interconnecting separate stages of a compressor or a compressor and an intercooler of an internal combustion engine. The duct comprises a lumen for conveying compressed air and at least one channel for a cooling liquid, which channel at least partially surrounds the lumen and/or extends inside the lumen. The duct enables effective cooling of compressed air e.g. from 260° C. to 220° C. at a relatively low pressure drop, thus increasing service life of downstream equipment, in particular a downstream intercooler.

### BACKGROUND

The discussion below is merely provided for general background information and is not intended to be used as an aid in determining the scope of the claimed subject matter.

As is explained in European patent application 1 048 832, supercharged engines are generally provided with an intercooler disposed in the supercharging duct and adapted to cool the air leaving the turbocharger unit before it is admitted into the intake manifold. The intercooler typically comprises an air-air heat exchanger, which is disposed in front of the main radiator of the vehicle and through which the flow of air produced by a fan associated with said radiator passes.

To further improve cooling, the supercharged internal-combustion engine (1) according to European patent application 1 048 832 comprises—in addition to the usual turbocharger (3), supercharging duct (7) connecting an outlet of the turbocharger (3) to an intake manifold of the engine (1), intercooler (8) in series with the supercharging duct (7) for cooling the supercharging air of the engine, and forced-ventilation device (14) for cooling the supercharging duct (7) at least one ducting (18,19) having an inlet aperture (20) facing a fan (10) and an outlet aperture (21) facing a portion (16,17) of the supercharging duct (7).

U.S. Pat. No. 4,236,492 relates to an internal combustion engine having a supercharger and two or more supercharger intercoolers or cooling systems respectively having different temperature levels. The individual coolers are arranged in succession in the direction of flow, with the charged air decreasing in temperature and the cooling air increasing in temperature. The embodiment in FIGS. 2 and 3 comprises one respectively two liquid cooled supercharger intercoolers (11, 12) and an air cooled supercharger intercooler (5).

With increasing turbocharger pressure ratios, necessary for improving the efficiency of internal combustion engines, the temperature of the compressed gas leaving the compressor or a compressor stage also increases. At present, typical pressures and temperatures of gas leaving the compressor are e.g. 4 bar and 260 to 290° C. (depending on ambient temperature). At such conditions, the gas is likely to damage downstream equipment, in particular a downstream intercooler.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the background.

An aspect of the present invention is a duct comprising at least one channel for a cooling liquid, which channel at least partially surrounds the lumen for conveying compressed air and/or extends inside the lumen and preferably across the lumen. In one embodiment, at least one of the channels undulates. The duct can also include fins and/or projections extending inside the lumen.

The duct, also referred to as “supercharging duct” or “boostpipe”, enables effective cooling of compressed air e.g. from 260° C. to 220° C. at a relatively low pressure drop, thus increasing service life of downstream equipment, in particular a downstream intercooler.

To further increase the efficacy of the duct and the freedom of design, the duct can be formed by molding, for instance by sand-, lost foam- or permanent die molding, a metal, such as aluminium, such that the walls of the lumen and the channel(s) and, if present, the fins and/or projections, form an integral whole formed from a single unitary body.

Another aspect of the invention also relates to an internal combustion engine, in particular a diesel engine for commercial vehicles, comprising a compressor, an intercooler, and a duct interconnecting separate stages of the compressor and/or an outlet of the compressor and an inlet of the intercooler.

### BRIEF DESCRIPTION OF THE DRAWINGS

The invention will now be illustrated with reference to the drawings, which schematically show a preferred embodiment of the present duct. It is noted that the drawings are not necessarily to scale and that details, which are not required for understanding the present invention, may have been omitted. Further, elements that are at least substantially identical or that perform an at least substantially identical function are denoted by the same numeral.

FIGS. 1 and 2 are a perspective view and a top view of a boostpipe.

FIGS. 3 to 5 are cross-sections (III-III; IV-IV; V-V) of the boostpipe shown in FIGS. 1 and 2.

FIGS. 6 and 7 are perspective views of two sand cores for defining internal features of the boostpipe.

### DETAILED DESCRIPTION

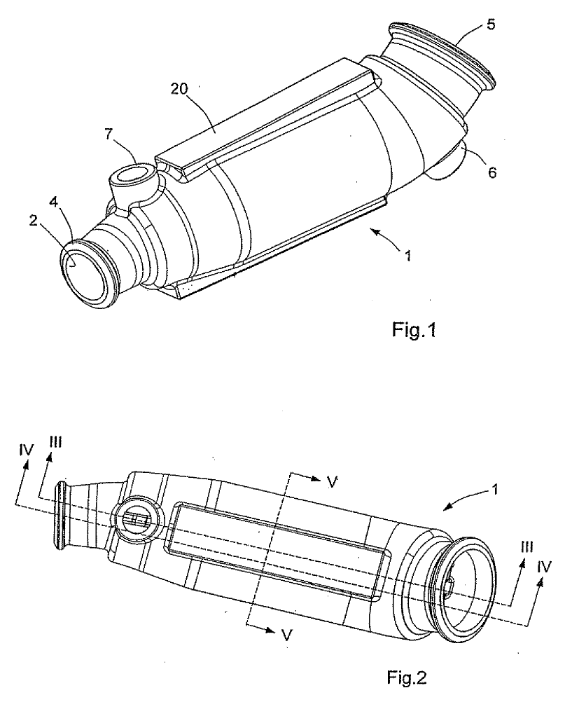

FIGS. 1 to 5 show a boostpipe 1 for interconnecting a stage of a compressor, such as a turbo-compressor or a supercharger, and/or the compressor and an intercooler of an internal combustion engine, for example, a diesel engine of a commercial vehicle, such as truck. Blocks 20 and 21 represent stages of the compressor, or the compressor and the intercooler. These combined elements herein represent an internal combustion engine that need not further described for understanding the aspects of the invention herein described.

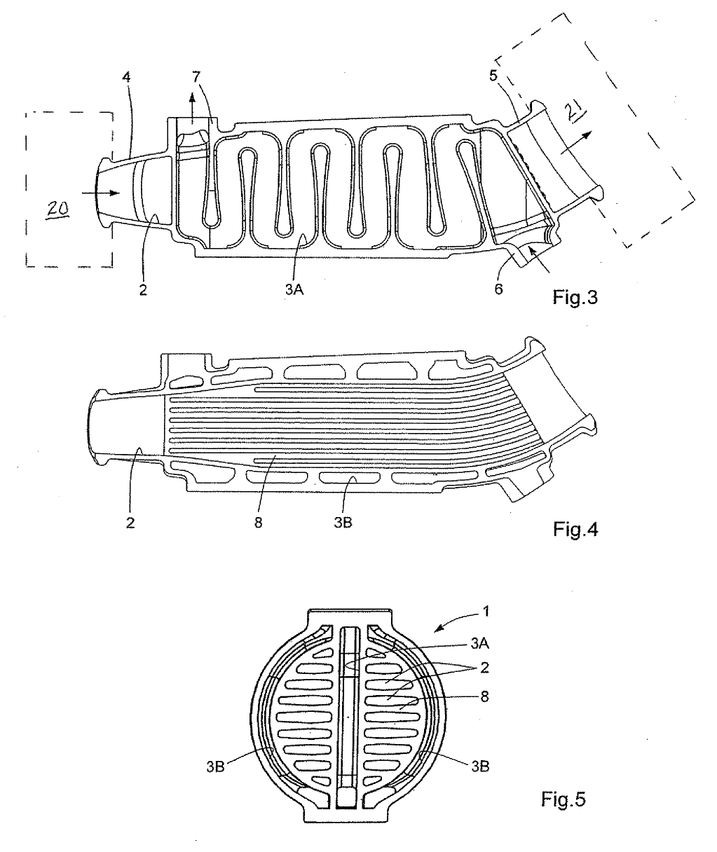

The boostpipe 1 comprises a lumen 2 for conveying compressed air from the compressor to the intercooler (or stages of the compressor), a plurality of channels 3 (FIGS. 3 to 5) for conveying a cooling liquid, typically water, in- and outlets 4, 5 for compressed air and in- and outlets 6, 7 for the cooling liquid. The in- and outlets 4, 5 for compressed air are provided with radially protruding rims, which facilitate connecting the boostpipe 1, for example by means of V-clamps (not shown), to the compressor and the intercooler.

In this example, the lumen 2 diverges in the flow direction and the centreline of the internal lumen 2 and indeed the entire boostpipe 1 is gradually curved in two directions. The position and inclination of the in- and outlets 4, 5 for compressed air have been adapted to the position of the outlet of the compressor respectively the inlet of the intercooler of a specific engine (as such the configuration of these elements of boostpipe 1 may change from engine to engine). As a result, pressure drop will be relatively low and in principle no additional pipes or ducts are required to interconnect the said compressor and intercooler by means of the liquid-cooled boostpipe 1.

Further, in this example, the channels 3 for conveying the cooling liquid are three in number, one undulating channel 3A extending across—i.e. through the middle and over the entire diameter of—the lumen 2 and two channels 3B undulating about the lumen 2, each spanning in one embodiment at least 150° of the circumference of the lumen 2. Also, the channels can extend over a substantial part, preferably at least 70% of the length of the boostpipe.

To further enhance heat exchange, fins 8 can be provided. In the exemplary embodiment, fins 8 extend in the longitudinal direction of the boostpipe 1 and in the transverse direction, interconnecting the inner wall of the lumen 2 and the middle channel 3A.

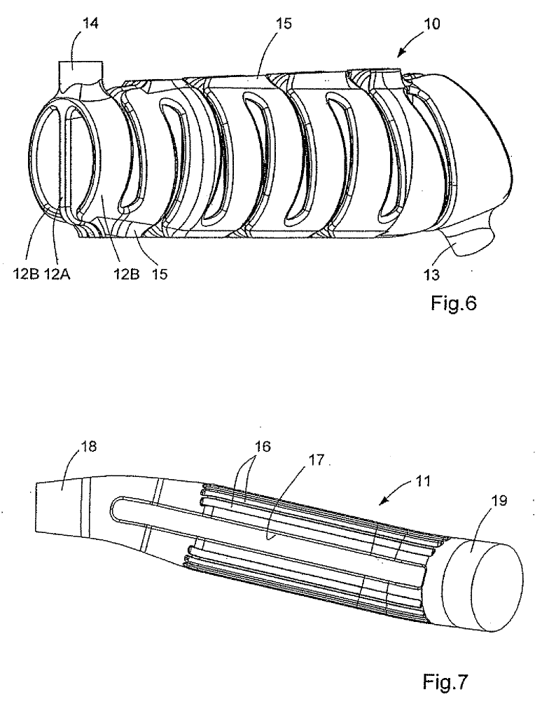

FIGS. 6 and 7 show sand cores 10, 11 for molding the boostpipe 1 in FIGS. 1 to 5 as an exemplary method of manufacturing boostpipe 1. The sand core 10 shown in FIG. 6 defines the cooling channels and comprises three undulating (serpentine) sections 12 defining the channels 3 for the cooling liquid, stubs 13, 14 defining the in- and outlets (G, 7) common to these channels 3, and core marks 15 for securing the sand core 10 inside a (sand) mold. The sand core shown in FIG. 7 defines the lumen for the compressed gas and comprises a plurality of substantially parallel lamellae 16 defining the spaces in between the fins 8, a slot 17 extending substantially perpendicular to the lamellae 16 for accommodating the middle section 12A of the sand core in FIG. 6, and stubs 18, 19 defining the in- and outlets (4, 5) for the compressed gas as well as for securing the sand core inside the mold.

During production, the sand core 11 for the lumen, which consists of at least two parts, is positioned inside the sand core 10 for the cooling channels and glued together. Subsequently, the cores 10, 11 are placed in a sand mold and a metal, such as aluminium, is poured into the mold, in a manner known in itself. After the metal has cooled down the semi-finished product is removed from the mold and the sand is removed from the lumen 2 and the channels 3. Finally, strips 20 are welded into the openings resulting from the core marks 15, thus rendering the channels 3 liquid-tight.

It is noted that other core mark systems are also possible, such as systems involving the use of press-fitted plugs. Further, if no middle channel (3A) is present, the core (11) for the lumen may consist of a single part (no gluing required).

The boostpipe 1 is particular advantageous because it takes up only slightly more space than a similar existing boostpipe without cooling and (thus) can be fitted in existing engine designs. The boostpipe can be connected e.g. to the main cooling system of the engine or a separate system. Experiments have shown that the boostpipe according to this example allows effective cooling of compressed air e.g. from 260° C. to 220° C. (at relatively low ambient temperature) or from 290° C. to 230° C. (at relatively high ambient temperature), thus preventing damage to the downstream intercooler.

Although the subject matter has been described in language specific to structural features and/or methodological acts, it is to be understood that the subject matter defined in the appended claims is not necessarily limited to the specific features or acts described above as has been determined by the courts. Rather, the specific features and acts described above are disclosed as example forms of implementing the claims and can be varied in a number of ways within the scope of the claims. For instance, the duct can be positioned between separate stages of a compressor, i.e. cool the compressed air from an upstream stage before it enters a downstream stage.

What is claimed is:

1. A duct for interconnecting separate stages of a compressor or a compressor and an intercooler of an internal combustion engine, which duct comprises a lumen for conveying compressed air and at least one channel for a cooling liquid, which channel at least partially surrounds the lumen and/or extends inside the lumen.

2. The duct according to claim 1, wherein at least one channel for a cooling liquid extends inside and across the lumen.

3. The duct according to claim 1, wherein at least one of the channels for a cooling liquid undulates about at least part of respectively inside the lumen.

4. The duct according to claim 1 and further comprising fins and/or projections extending inside the lumen.

5. The duct according to claim 4, wherein the f ins and/or projections interconnect an inner wall of the lumen and the at least one of the channel for a cooling liquid extending inside the lumen.

6. The duct according to claim 5 and wherein walls of the lumen, the at least one channel and the fins and/or projections, form an integral whole as a single unitary body.

7. The duct according to claim 5 wherein the lumen comprises a molded lumen.

8. The duct according to claim 7 wherein the lumen is formed from a metal.

9. The duct according to claim 8 wherein the lumen is formed aluminium.

10. An internal combustion engine comprising a compressor, an intercooler, and a duct disposed between stages of the compressor and/or an outlet of the compressor and an inlet of the intercooler, the duct a lumen for conveying compressed air and at least one channel for a cooling liquid, which channel at least partially surrounds the lumen and/or extends inside the lumen.

11. The internal combustion engine according to claim 10, wherein the lumen for compressed air diverges towards the intercooler.

12. The internal combustion engine according to claim 10, wherein at least one channel for a cooling liquid extends inside and across the lumen.

13. The internal combustion engine according to claim 10, wherein at least one of the channels for a cooling liquid undulates about at least part of respectively inside the lumen.

14. The internal combustion engine according to claim 10 and further comprising fins and/or projections extending inside the lumen.

15. The internal combustion engine according to claim 12, wherein the fins and/or projections interconnect an inner wall of the lumen and the at least one of the channel for a cooling liquid extending inside the lumen.

16. The internal combustion engine according to claim 15 wherein walls of the lumen, the at least one channel and the fins and/or projections form an integral whole as a single unitary body.
